(19) United States
(12) Patent Application Publication
(10) Pub. No.: US 2026/0077636 A1
(43) Pub. Date: Mar. 19, 2026

(54) CASTING HOUSING FOR A DOOR MOTION ASSEMBLY

(71) Applicants: Lawrence M. PLOURDE, JR., Macomb, MI (US); David W. CUMMINGS, Clinton Township, MI (US); MAGNA INTERNATIONAL INC., Aurora (CA)

(72) Inventors: Lawrence M. PLOURDE, Jr., Macomb, MI (US); David W. CUMMINGS, Clinton Township, MI (US)

(21) Appl. No.: 19/109,187

(22) PCT Filed: Sep. 7, 2023
(86) PCT No.: PCT/US2023/032173

§ 371 Date: Mar. 6, 2025

Related U.S. Application Data
(60) Provisional application No. 63/405,031, filed on Sep. 9, 2022.

(51) Int. Cl. B60J 5/04; B62D 25/02; B62D 25/04

(52) U.S. Cl. CPC B60J 5/047; B60J 5/042; B62D 25/025; B62D 25/04; B60J 2005/0475

(57) ABSTRACT

A casting housing for a vehicle body having an enlarged passenger opening includes a body extending from a first housing end to a second housing end to define a compartment. At least one of a front door pivot-type door motion assembly is disposed within the compartment adjacent the first housing end or a rear door pivot-type door motion assembly is disposed within the compartment adjacent the second housing end, with preferably both disposed within the compartment. The casting housing is attached to the vehicle body, preferably along a lower body side rocker structure, to indirectly attach the front and/or rear door pivot-type door motion assemblies to the vehicle body at any time during manufacture of the vehicle, after which the front and rear doors are attached to the front and rear pivot-type door motion assemblies for pivoting the doors relative to the enlarged door opening between open and closed positions.

### CROSS-REFERENCE TO RELATED APPLICATIONS

This PCT International Patent Application claims the benefit of and priority to U.S. Provisional Patent Application Ser. No. 63/405,031, filed Sep. 9, 2022, titled “Casting Housing For A Door Motion Assembly,” the entire disclosure of which is hereby incorporated by reference.

### BACKGROUND OF THE INVENTION

### 1. Field of the Invention

The present disclosure relates to a door motion assembly for a vehicle including at least a front door or a rear door, and preferably both. More specifically, the present disclosure relates to a pivot-type door motion assembly for a vehicle for pivoting a front and/or rear door between open and closed positions relative to a door opening of the vehicle.

### 2. Related Art

This section provides background information related to the present disclosure which is not necessarily prior art.

Vehicle doors are typically located within a door frame of a vehicle body to provide access to a passenger compartment. As illustrated in FIGS. 1-2, in some cases the vehicle body 10 is formed with an enlarged door opening 12 without a structural B-pillar. In such cases, the vehicle body 10 can be equipped with at least one pivot-type door motion assembly, and preferably both a front pivot-type door motion assembly and a rear pivot type door motion assembly for translating and pivoting front and rear doors between open and closed positions relative to the enlarged door opening. While the pivot-type door motion assemblies provide some benefits for effectuating this pivoting movement of the front and rear doors they are not without shortcomings. For example, the front and rear pivot-type door motion assemblies are often attached directly to the vehicle body 10, encroaching on space required for other components of the vehicle, such as driveline or transmission components for a traditional ICE vehicle, or battery space for an electrical vehicle structure. Additionally, attachment of the front and rear pivot-type door motion assemblies directly to the vehicle body can also negatively affect hard points of the vehicle body, such as the wheelbase, etc. Accordingly, there is a continuing need to develop optimized packaging and attachment of the pivot-type door motion assemblies to the vehicle body, especially when the vehicle body lacks the b-pillar and has an enlarged passenger opening.

### SUMMARY OF THE INVENTION

The subject invention is directed to a casting housing for packaging and indirectly attaching at least one pivot-type door motion assembly to a vehicle body. The casting housing includes a body extending from a first housing end to a second housing end to define a compartment. At least one of a front door pivot-type door motion assembly is disposed or housed within the compartment adjacent the first housing end and/or a rear door pivot-type door motion assembly is disposed or housed within the compartment adjacent the second housing end. As best illustrated in FIG. 1, the casting housing is packaged with the front and/or rear door pivot-type door motion assemblies pre-assembled within the compartment for attachment to the vehicle body as a complete module, preferably along the lower body side rocker structure, during assembly of the vehicle. This advantageously allows the casting housing and the packaged front and/or rear door pivot-type door motion assemblies to be installed either before or after painting of the vehicle body. The casting housing can also be subsequently removed from the vehicle after manufacturing, with the pivot-type door motion assemblies packaged and housed therein, such as for requisite service or replacement. Since the pivot-type door motion assemblies are packaged in the casting housing as a complete module, the attachment of the casting housing to the vehicle body, such as along the lower body side rocker structure, addresses the space and encroachment issues in the prior designs.

### BRIEF DESCRIPTION OF THE DRAWINGS

Other aspects and advantages of the present disclosure will be readily appreciated, as the same becomes better understood by reference to the following detailed description when considered in connection with the accompanying drawings wherein:

FIG. 1 is a perspective view of a vehicle body formed with an enlarged door opening and including a lower body side structure extending between a front wheel well opening and a rear wheel well opening;

FIG. 2 is a perspective view of the vehicle body including a casting housing packaged with a front and rear pivot-type door motion assembly and secured to the vehicle body along the lower body side rocker structure;

FIG. 3 is a perspective view of a front door and a rear door of a vehicle for attachment to the respective front and rear pivot-type door motion assemblies illustrated in FIG. 2;

FIG. 4 is a perspective view of the casting housing more clearly illustrating a compartment of the casting housing extending between a first housing end and a second housing end and the front pivot-type motion assembly disposed within the compartment adjacent the first housing end and the rear pivot-type motion assembly disposed within the compartment adjacent the second housing end;

FIG. 5 is a cross-sectional view of the casting housing taken along the cross-sectional plane 5-5 in FIG. 4 illustrating a pivot actuator of the pivot-type motion assembly disposed within a pocket of the compartment and a hinge mechanism of the pivot-type motion assembly extending through a slot defined by the casting housing and along the compartment towards the second housing end;

FIG. 6 is a cross-sectional view of the casting housing taken along the same cross-sectional plane 5-5 in FIG. 3 but with the pivot actuator and hinge mechanism removed (See cross-sectional plane 8-8 in FIG. 8) to more clearly illustrate the pocket and the slot in the compartment of the casting housing;

FIG. 7 is a perspective view of the vehicle body illustrating only the casting housing secured along the lower body-side rocker structure;

FIG. 8 is a perspective view of the casting housing with the front and rear pivot-type motion assemblies removed to more clearly illustrate the compartment having the pockets and the slots for use in packaging the front and rear pivot-type motion assemblies within the casting housing;

FIG. 9 is a perspective view of the vehicle body illustrating a seal extending around a perimeter of the casting housing and the compartment;

FIG. 10 is a perspective view of the vehicle body illustrating only the casting housing secured along the lower body-side rocker structure to more clearly illustrate the seal shown in FIG. 9; and

FIG. 11 is a cross-sectional view of the vehicle body and casting housing taken along the cross-sectional plane 11-11 in FIG. 10 to illustrate the seal disposed in sealed relationship with a front and/or rear door in the closed position.

### DESCRIPTION OF THE ENABLING EMBODIMENTS

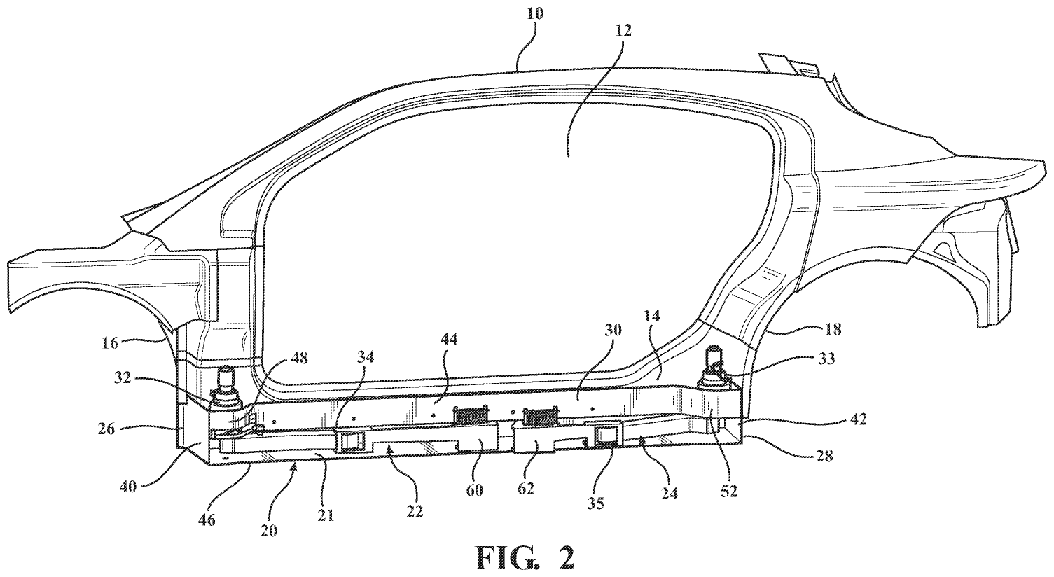

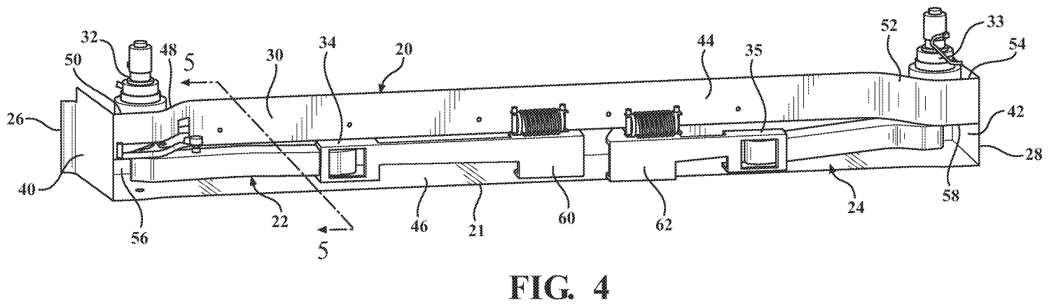

Example embodiments will now be described more fully with reference to the accompanying drawings. In general, the subject embodiment is directed to a casting housing 20 formed separate and distinct from a vehicle body 10 for packaging and indirectly securing at least one pivot-type door motion assembly 22, 24 to the vehicle body 10, preferably along a lower body side rocker structure 14. As best illustrated in FIGS. 2 and 4, the casting housing 20 preferably packages both a front pivot-type door motion assembly 22 as well as a rear pivot-type door motion assembly 24, and then the casting housing 20 is secured to the vehicle body 10 as a complete module to indirectly attach the front and/or rear pivot-type door motion assemblies to the vehicle during manufacturing. As described above, the casting housing 20 provides flexibility with regard to when and where the front and rear pivot-type door motion assemblies 22, 24 are attached to the vehicle body 10 during manufacturing of the vehicle, with a design that minimizes encroachment on the space required for other components of the vehicle.

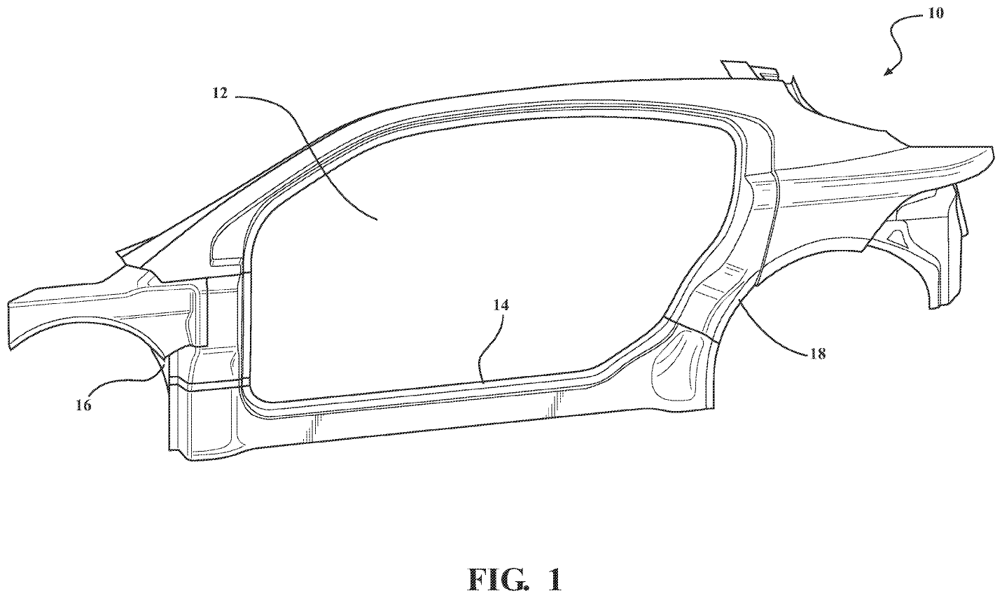

As best illustrated in FIG. 1, the vehicle body 10 is formed with an enlarged door opening 12—i.e., one without a structural b-pillar—and includes a lower body side rocker structure 14 extending between a front wheel well opening 16 and a rear wheel well opening 18. As best illustrated in FIGS. 2, 4 and 7-9, the casting housing 20 includes a body 21 extending between a first housing end 26 and a second housing end 28 to define a compartment 30 extending therebetween. The casting housing 20 is preferably comprised of aluminum and formed as a one-piece integrally cast design. However, different materials and a multiple (e.g., two) piece casting design could be utilized without departing from the scope of the subject disclosure. As further illustrated in FIGS. 2 and 4, a front door pivot-type door motion assembly 22 is housed or packaged within the compartment 30 adjacent the first housing end 26 and a rear door pivot-type door motion assembly 24 is housed or packaged within the compartment 30 adjacent the second housing end 28. As best illustrated in FIG. 2, the casting housing 20 packaged or pre-assembled with the front and rear door pivot-type door motion assemblies 22, 24 as a complete module is attached or assembled to the vehicle body 10, such as by securing the casting housing 20 to the vehicle body 10 via welding, mechanical fasteners 31 (See FIG. 11), or the like.

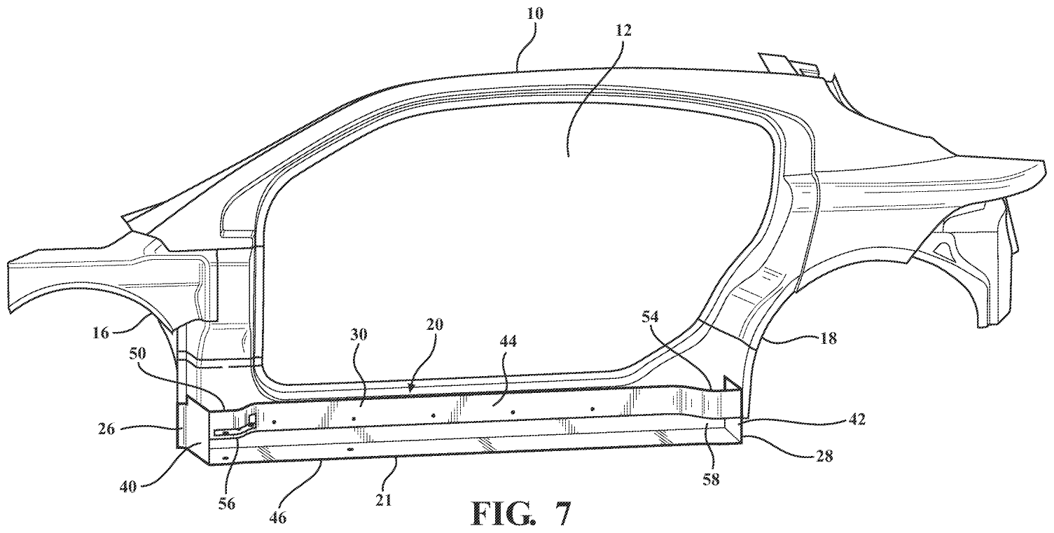

As best illustrated in FIGS. 2 and 4, the front pivot-type door motion assembly 22 includes a front pivot actuator 32 and a front hinge mechanism 34 operably connected to and extending from the front pivot actuator 32 for effectuating pivoting or translational movement of the front door 36 between an open and closed position when the casting housing 20 is assembled to the vehicle body 10. Similarly, the rear pivot-type door motion assembly 24 includes a rear pivot actuator 33 and a rear hinge mechanism 35 operably connected to and extending from the rear pivot actuator 33 for effectuating pivoting or translational movement of the rear door 38 between an open and closed position when the casting housing 20 is assembled to the vehicle body 10. As best illustrated in FIGS. 2, 4 and 7-9, the body 21 of the casting housing 20 includes a first end wall 40 disposed adjacent the first housing end 26 and a second end wall 42 disposed adjacent the second housing end 28. The body 21 of the casting housing 20 also includes a side wall 44 extending from adjacent each of the first and second end walls 40, 42, and a bottom wall 46 extending between the first and second walls 40, 42 in generally perpendicular relationship to the side wall 44 and the first and second end walls 40, 42 to collectively define the compartment 30 bounded by the first and second end walls, 40, 42, the side wall 42 and the bottom wall 46. As best illustrated in FIGS. 2 and 7, the side wall 42 extends along the lower body side rocker structure 14 in abutting and overlaying relationship when the casting housing 20 is attached to the vehicle body 10.

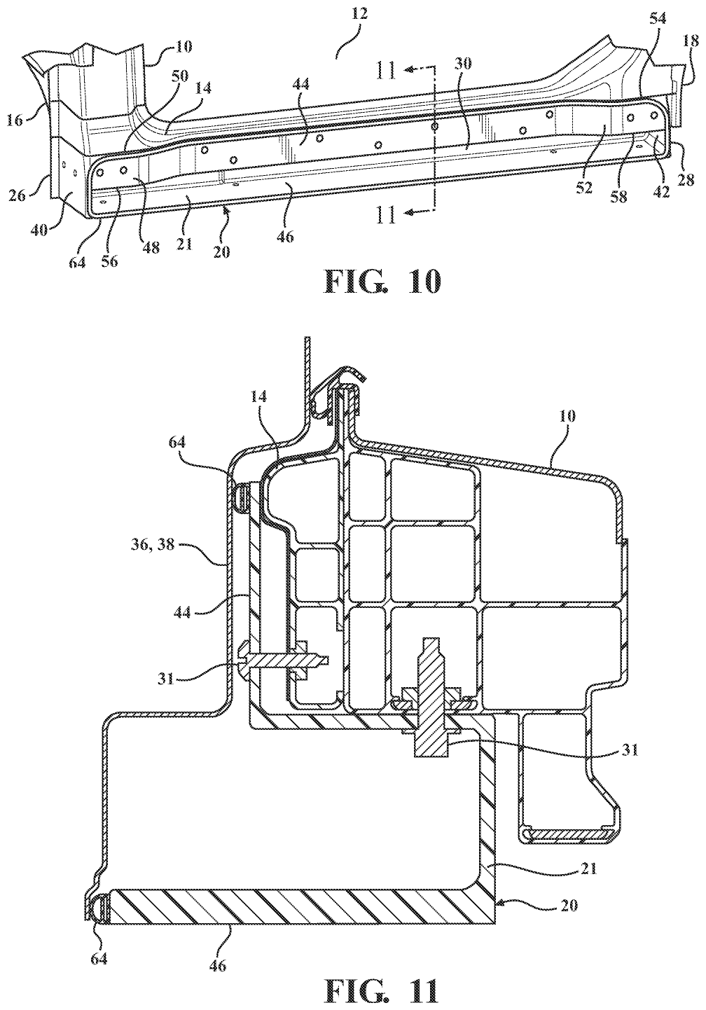

As best illustrated in FIGS. 7-10, the casting housing 20 includes a first flange 48 extending between the first end wall 40 and the side wall 44 to define a first pocket 50 in the compartment 30 that is collectively bounded by the first end wall 40, the side wall 44 and bottom wall 46 adjacent the first housing end 22. The casting housing 20 also includes a second flange 52 extending between the second end wall 42 and the side wall 44 to define a second pocket 54 in the compartment 30 that is collectively bounded by the second end wall 42, the side wall 44 and the bottom wall 46 adjacent the second housing end 24. As best illustrated in FIGS. 2 and 4-5, the front pivot actuator 32 of the front pivot-type door motion assembly 22 is packaged or housed within the first pocket 50 of the compartment 30 and the rear pivot actuator 33 of the rear pivot-type door motion assembly 24 is packaged or housed within the second pocket 54 of the compartment. Each of the first and second pockets 50, 54 are designed to secure the respective front and rear pivot actuators 32, 33 within the compartment 30 of the casting housing 20 and prevent movement when the casting housing 20 is secured to the vehicle body 10 as well as when the vehicle is subsequently under operation. Each of the first and second flanges 48, 52 are preferably arcuately shaped to complement a circular shape of the front and rear actuator pivots 32, 33 and provide a snug fit of the front and rear pivot actuators 32, 33 when packaged within the casting housing 20. However, other shapes could be utilized, depending on alternative shapes of the front and rear pivot actuators 32, 33, without departing from the scope of the subject disclosure.

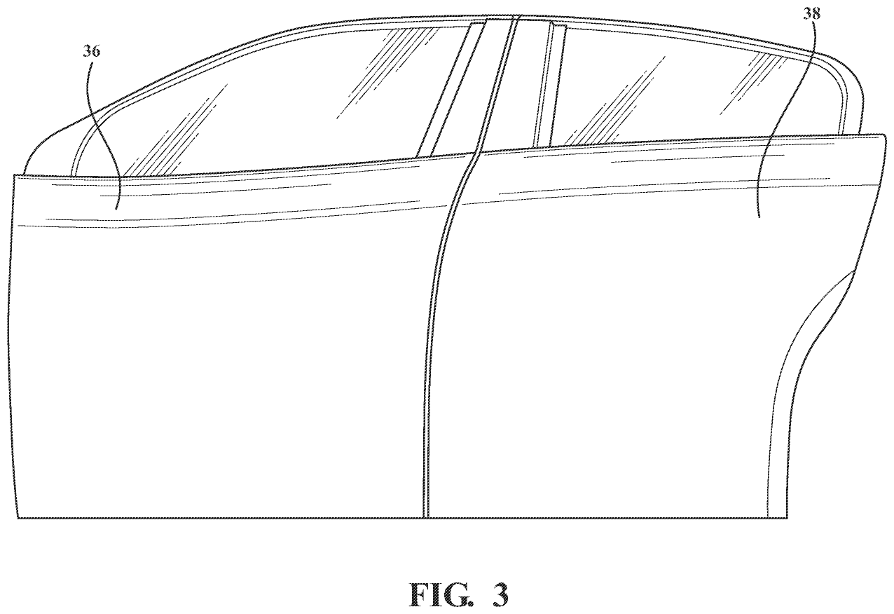

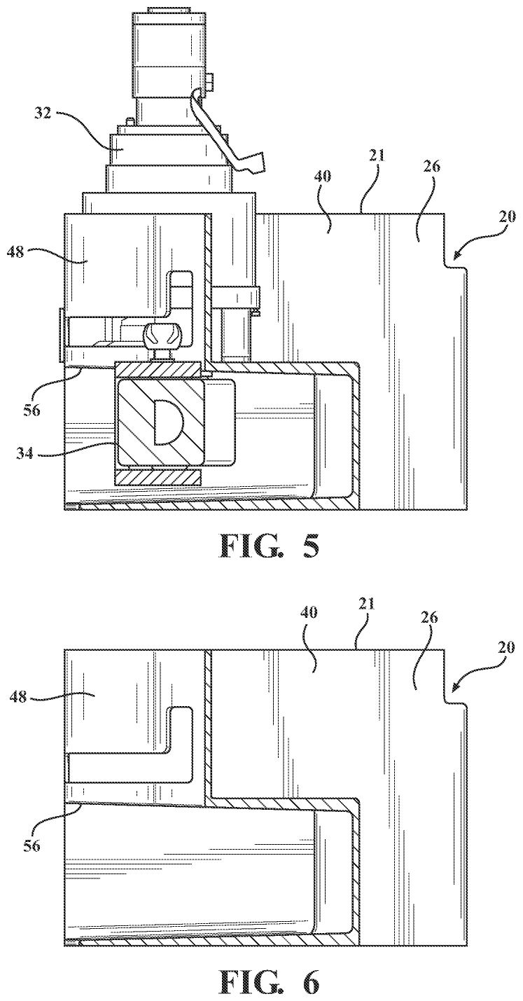

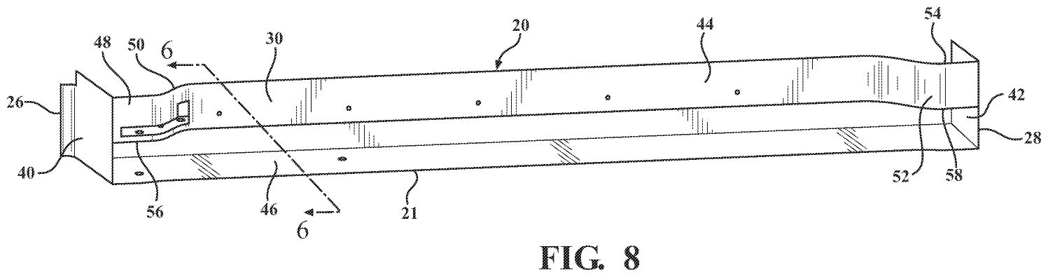

As best illustrated in FIGS. 7-8, the first flange 48 is disposed in spaced relationship with the bottom wall 46 to define a first slot 56 adjacent the first pocket 50 and the second flange 52 is disposed in spaced relationship with the bottom wall 46 to define a second slot 58 adjacent the second pocket 54. As best illustrated in FIGS. 2 and 4, the front hinge mechanism 34 of the front pivot-type door motion assembly 22 is operably attached to the front pivot actuator 32 and extends through the first slot 42 and along the compartment 26 to terminate at a front connector 60 for attachment to the front door 36. Similarly, the rear hinge mechanism 35 of the rear pivot-type door motion assembly 24 is operably attached to the rear pivot actuator 33 and extends through the second slot 58 and along the compartment 26 to terminate at a rear connector 62 for attachment to the rear door 38. FIGS. 5 and 6 provide cross-sectional views taken along FIGS. 3 and 8 to provide a clearer illustration of the first and second pockets 50, 54 and the first and second slots 56, 58 defined by the casting housing 20.

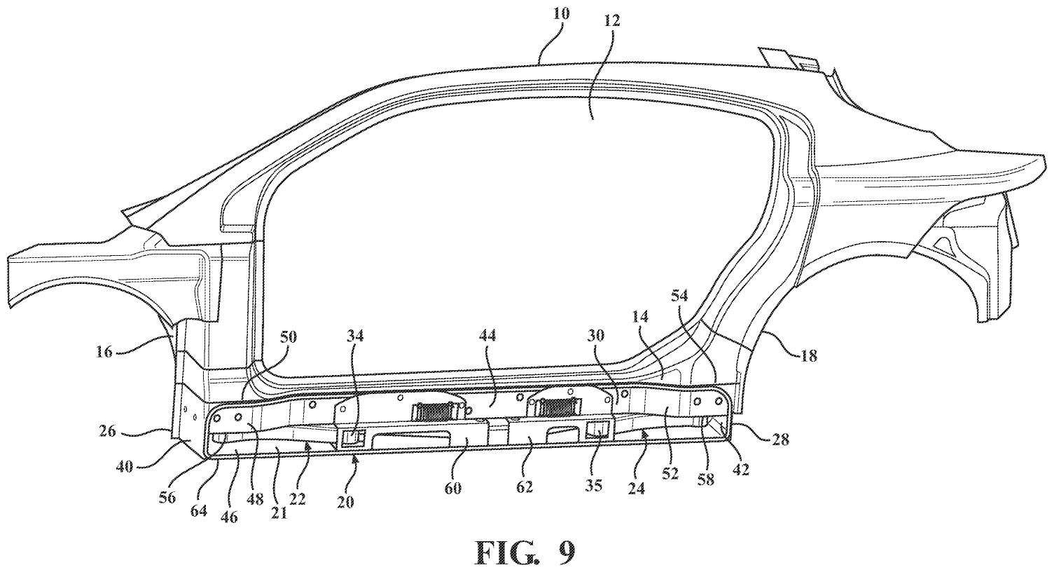

As illustrated in FIGS. 9-11, in accordance with an aspect, a seal 64 can extend around a perimeter of the casting housing 20 and the compartment 30 for being disposed in abutting and sealed relationship with a front and/or rear door 36, 38 in the closed position (See FIG. 11). More specifically, the seal 64 can extend continuously along end portions of the first and second end walls 40, 42, the side wall 44 and the bottom wall 46 to establish a sealing strategy for the compartment 30 of the casting housing 20, and the front and rear pivot-type door motion assemblies 22, 24 disposed therein.

As mentioned previously, attachment of the casting housing 20 to the vehicle body 10 can advantageously occur either before or after a painting process of the vehicle, after which the front and rear doors 36, 38 are attached to the front and rear connectors 60, 62 of the respective front and rear pivot-type door motions assemblies 22, 24 for use in opening and closing the doors 36, 38 relative to the enlarged door opening 12 of the vehicle body 10. While the casting housing 20 is described in relation to pivot-type door motion assemblies, the example embodiments are only provided so that this disclosure will be thorough, and will fully convey the scope to those who are skilled in the art. It will be apparent to those skilled in the art that specific details need not be employed, that example embodiments may be embodied in many different forms (such as use of the casting housing 20 with other types of door motion assemblies) and that neither should be construed to limit the scope of the disclosure. In some example embodiments, well-known processes, well-known device structures, and well-known technologies are not described in detail.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A casting housing for attachment to a vehicle body having an enlarged passenger opening, the casting housing comprising:
a body extending from a first housing end to a second housing end to define a compartment extending therebetween; and
at least one of a front door pivot-type door motion assembly disposed within said compartment adjacent said first housing end or a rear door pivot-type door motion assembly disposed within said compartment adjacent said second housing end.

2. The casting housing as set forth in claim 1, wherein both said front door pivot-type door motion assembly is disposed within said compartment adjacent said first housing end and said rear door pivot-type door motion assembly is disposed within said compartment adjacent said second housing end.

3. The casting housing as set forth in claim 2, wherein said body includes a first end wall disposed adjacent said first housing end, a second end wall disposed adjacent said second housing end, a side wall extending between adjacent said first and second end walls, and a bottom wall extending between said first and second housing ends in generally perpendicular relationship to said first and second end walls and said side wall to collectively define said compartment.

4. The casting housing as set forth in claim 3, wherein said body includes a first flange extending between said first end wall and said side wall to define a first pocket of said compartment adjacent said first housing end and a second flange extending between said second end wall and said side wall to define a second pocket of said compartment adjacent said second housing end.

5. The casting housing as set forth in claim 4, wherein said front pivot-type door assembly includes a front pivot actuator disposed within said front pocket and said rear pivot-type door assembly includes a rear pivot type actuator disposed within said rear pocket.

6. The casting housing as set forth in claim 5, wherein each of said first and second flanges are arcuate shaped.

7. The casting housing as set forth in claim 5, wherein said first flange is disposed in spaced relationship with said bottom wall to define a first slot adjacent said first pocket and said second flange is disposed in spaced relationship with said bottom wall to define a second slot adjacent said second pocket.

8. The casting housing as set forth in claim 7, wherein said front pivot-type door assembly includes a front hinge mechanism operably connected to said front pivot actuator and extending through said first slot and along said compartment to terminate at a front connector for attachment to a front door, and said rear pivot type door assembly includes a rear hinge mechanism operably connected to said rear pivot actuator and extending through said second slot and along said compartment to terminate at a rear connector for attachment to a rear door.

9. The casting housing as set forth in claim 7, wherein said body is formed as a one-piece integrally cast design.

10. The casting housing as set forth in claim 7, further comprising a seal extending along a perimeter of said compartment for being disposed in abutting and sealed relationship with the front and/or rear door in the closed position.

11. A vehicle body having an enlarged passenger opening, the vehicle body comprising:
a lower body side rocker structure extending from a front wheel well opening to a rear wheel well opening;
a casting housing formed separately from said lower body side rocker structure and extending from a first housing end to a second housing end to define a compartment;
at least one of a front door pivot-type door motion assembly disposed within said compartment of said casting housing adjacent said first housing end or a rear door pivot-type door motion assembly disposed within said compartment of said casting housing adjacent said second housing end; and
said casting housing secured to the vehicle body along said lower body side rocker structure.

12. The vehicle body as set forth in claim 11, wherein both said front door pivot-type door motion assembly is disposed within said compartment adjacent said first housing end and said rear door pivot-type door motion assembly is disposed within said compartment adjacent said second housing end.

13. The vehicle body as set forth in claim 12, further comprising:
said casting housing including a first end wall disposed adjacent said first housing end, a second end wall disposed adjacent said second housing end, a side wall extending from adjacent said first and second end walls, and a bottom wall extending between said first and second housing ends in generally perpendicular relationship to said first and second end walls and said side wall to collectively define said compartment; and
said side wall extending in abutting and overlaying relationship with said lower body side rocker structure.

14. The vehicle body as set forth in claim 13, wherein said casting housing includes a first flange extending between said first end wall and said side wall to define a first pocket of said compartment adjacent said first housing end and a second flange extending between said second end wall and said side wall to define a second pocket of said compartment adjacent said second housing end.

15. The vehicle body as set forth in claim 14, wherein said front pivot-type door assembly includes a front pivot actuator disposed within said front pocket of said compartment and said rear pivot-type door assembly includes a rear pivot type actuator disposed within said rear pocket of said compartment.

16. The vehicle body as set forth in claim 15, wherein each of said first and second flanges are arcuate shaped.

17. The vehicle body as set forth in claim 15, wherein said first flange is disposed in spaced relationship with said bottom wall to define a first slot adjacent said first pocket and said second flange is disposed in spaced relationship with said bottom wall to define a second slot adjacent said second pocket.

18. The vehicle body as set forth in claim 17, wherein said front pivot-type door assembly includes a front hinge mechanism operably connected to said front pivot actuator and extending through said first slot and along said compartment to terminate at a front connector for attachment to a front door, and said rear pivot type door assembly includes a rear hinge mechanism operably connected to said rear pivot actuator and extending through said second slot and along said compartment to terminate at a rear connector for attachment to a rear door.

19. The vehicle body as set forth in claim 17, wherein said casting housing is formed as a one-piece integrally cast design.

20. The vehicle body as set forth in claim 17, further comprising a seal extending along a perimeter of said compartment for being disposed in abutting and sealed relationship with the front and/or rear door in the closed position.
